(19) United States
(12) Patent Application Publication
(10) Pub. No.: US 2007/0141359 A1
(43) Pub. Date: Jun. 21, 2007

(54) Glassy film suitableto the method surface coatings and coated articles obtained thereby

(75) Inventors: Fulvio Costa, Sommo (IT); Lucia Gini, Novara (IT); Vincenzo Girardino, Novara (IT); Lorenzo Costa, Sommo (IT)

Correspondence Address: VENABLE LLP, P.O. BOX 34385, WASHINGTON, DC, 20043-9998, US

(73) Assignee: DEGUSSA NOVARA TECHNOLOGY S.P.A., PERO (IT)

(21) Appl. No.: 11/629,774

(22) PCT Filed: Jun. 25, 2004
(86) PCT No.: PCT/EP04/06869

§ 371 Date: Dec. 15, 2006

(51) Int. Cl. B32B 17/06; B32B 15/04

(52) U.S. Cl. 428/426; 428/432; 428/469

(57) ABSTRACT

The present invention relates to glassy inorganic films, characterized by a high chemical stability and a high adhesion, containing, among the others, titanium dioxide, employable to coat metal surfaces characterized by the presence of oxides, particularly stainless steel sheets. The coated structures obtained thereby, which are the second object of the present invention, are used to build many articles such as pipes, reactors, exchangers, containers, and so on. With reference to the peculiar case of stainless steel structures coated by the above film, these ones can be used in the food industry since that film coated article shows specific and very high photobactericide properties.

The present invention relates to glassy inorganic films, characterized by a high chemical stability and a high adhesion, containing, among the others, titanium dioxide, useful to coat metal surfaces containing oxides, particularly stainless steel sheets. The coated structures obtained thereby, consisting the second object of the present invention, are employed, in turn, to build many articles such as pipes, reactors, exchangers, containers, etc. As far as the stainless steel structures are concerned, when coated by the above referred film, they can be advantageously used in the food industry since the film coated article shows peculiar and very high photobactericide properties.

Materials are known having glassy coatings, the same being employed, because of their resistance against corrosive agents, in many industrial sectors: such materials are mainly made by composite structures comprising a ferrous substrate and a corrosion proof coating formed by a glassy layer adhering to that substrate. The glassy layer can for instance be obtained by letting a first layer adhere to the substrate and then a second layer cover the same: thus, according to U.S. Pat. No. 3,829,326, it is possible to prepare a corrosion and thermal change proof article through a subsequent layer application, such an article being constituted by a ferrous substrate, a first coating and a second layer in turn constituted by refractary material containing many oxides. The presence of clay components may sometimes cause the formation of gaseous bubbles which consequently weaken the protection of the iron surface coating.

Damage onto the steel surface glassy coating, such as the ones employed to build apparata to be used in the chemical, pharmaceutical or food industry, may occur also during the very use, and this damage standings may let the apparatus become useless, because of a continuous decay of the steel carrier. According to the European patent application no. 407.027 it is possible to repair the damaged section of the steel surface glassy coating by the application of a chemical composition on the very section, the subsequent change thereof into a phosphate glass through a sol-gel procedure and the final adhesion to the steel surface by heating. However the process is quite complex in that it comprises a chain of consecutive applications, it does not form the primary coating of the interested surface and, therefore, it does not change the kind and the employment made of the apparatus the damage has been overcome of.

The Applicant has now found that a phosphate base glassy film containing titanium dioxide constitutes, as such, a glassy coating having a high chemical stability and a very high adhesion to metal surfaces containing oxides (such as, for instance, stainless steel, aluminium, cast iron) and particularly to the stainless steel surfaces; the combination thereof produces a structure on which such coating shows the characteristics of a tenacious glass and which can be employed in many industrial sectors, mainly in the food field owing to its own photobactericide efficiency; furthermore the coating has such a resistance that breaks and damages are unlikely, the same being the disadvantages and the bounds of the known apparata.

Therefore, the first object of the present invention is an inorganic glassy film, having a high chemical stability, a very high adhesion to oxide containing metal surfaces, formed by a composition comprising at least an alkaline metal oxide, at least an oxide of an element belonging to the 3^{rd} Group of the Element Periodic System, at least one phosphorous oxide and titanium dioxide, this one in an amount not lower than 0.1% by weight.

As to the present invention purposes and the use relevant to coat stainless steel surfaces, a composition is particularly advantageous comprising sodium oxide, aluminium oxide, phosphorous trioxide and titanium dioxide, preferably according to the following weight percentages:
5%≦Na₂O≦65%
20%≦Al₂O₃≦70%
25%≦P₂O₃≦90%
0.1%≦TiO₂≦15%.

Overall, the use is particularly efficacious of a film in which the composition has a titanium dioxide percentage preferably ranging from 6% to 12%. Another particular and preferred embodiment is the use of titanium dioxide under a microcrystalline, mainly monocrystalline, well dispersed shape: anatase crystalline form is the most preferred one. The present invention film can be prepared, according to the methods well known to the skilled people, by titanium dioxide doping a previously obtained film containing the other components and, as such, already adhering to the surface to be coated, still according to usual procedures, alternatively, the interested surface can be coated by a film constituted by the oxides of the alkaline metal and the others, and, then, the layer obtained thereby can be coated by a titanium dioxide high content film.

Independently from the followed procedure, the coated structure is the second object and fall part of the present invention and, as a whole, consists of a metal carrier, mainly a stainless steel carrier, and a glass which, at the end of the adhesion and thermal treatment operations, shows the characteristics and the properties of a tenacious glass, in accordance with the technical definition well known to the skilled people, which ensure the coated structure to enjoy resistance and indestructibility qualities making the same to be extremely advantageous with respect to the ones till now known and industrially employed.

As above said, the preparation of the film according to the invention, i.e. the dosage of the many constituents as well as the adhesion of the mixture to the intersted substrate can be carried out according to the whatsoever technology employed in the field and well known to the skilled people: for instance, use can be made of the method disclosed in U.S. Pat. No. 4,193,808, in which a mixture of the relevant compounds is prepared in the desired amounts, the same are melted, and the resulting composition is cooled and dried to be finally cast onto the surface till to the final calcination.

Such preparation scheme is mentioned by way of an example, the same being atypical teaching how to enamel steel surfaces. However higher advantages are obtainable by preparing to coated structures according to the present invention through the so called sol-gel procedures, which warrant high precision and remarkable covering homogeneity.

It is known that the sol-gel procedures are chemical processes in which, starting from a mixture of suitable precursors (the so called “sol”), a simple or mixed oxide is produced under the shape of a tridimensional solid body or as the carrier thin layer. Sol-gel processes are disclosed in a lot of patent literature, for example in U.S. Pat. Nos. 4,574,063, 4,680,048, 4,810,674, 4,961,767, 5,207,814. The standing solutions generally employ, as solvents, water, alcohols or hydroalcohol mixtures. The precursors may be metalloid soluble salts, even if alcoxy derivatives thereof are more normally employed.

With reference to the composition of the film according to the present invention, a suitable phosphoric sol can be prepared (for instance, by using the reactants NaH₂PO₄, Al(i-pr.)₃, H₃PO₄ and H₂O to obtain a phosphoric glass with the basic composition of Na₂O Al₂O₃ P₂O₃), the sol can be doped by microcrystalline titanium dioxide, the film can be deposited onto the interested surface and the structure obtained thereby can be subjected to a thermal treatment.

Alternatively, the phosphoric sol can be directly deposited onto the interested surface, and the obtained structure can undergo the thermal treatment; subsequently a titanium dioxide containing film is deposited and a further thermal treatment is carried out.

The coated structure according to the present invention is obtained, in which the coating film, in turn, has the inventive composition.

The conditions and the procedures to carry out the sol-gel method are pertaining to the known art, the skilled people can refer to, such a known art being fully within the frame of the present specification. As to the thermal treatments, the structure undergo in the final step of the preparation process, the same are carried out in the 50° C.÷550° C. range, preferably in the 100° C.÷450° C. range.

Other explicative details are disclosed in the following illustrative examples, in which the fundamental ways are reported to carry out the necessary check of the technomechanical properties of the final products, as well as the photobactericide efficiency thereof.

The results of metallographic, morphologic and mechanical analyses made during the relevant search path outline the surprising properties of the film according to the present invention.

The first consideration is concerning with a fundamental morphologic item: the film thickness. The skilled people know that glassy films, prepared via sol-gel, hardly reach thickness above micrometer. Sometimes it happens, phototypes being however obtained under extreme process conditions as, for instance, according to Italian patent no. 1.306.214, in which a thick film is disclosed when sol-gel deposited and stabilized by thermal treatments at temperatures close to 1400° C.

Another example is reported in M. Manning et al., SPIE vol. 1758, Sol-gel optics II, (1992), pages 125÷134, wherein a composite film is disclosed, having a thickness of many micrometers. It is a ten years old technique having no industrial reliability. Simply, according to the relevant statistic, the glassy film deposited via sol-gel processes, is irreversibly eroding as it acquires a thickness letting it assume the glass mass characteristics. At this point, the hardness and the rigidity, combined with a poor stretch resistance, do not allow the survival thereof to the mainly stretching strength raising during the film gel densification, i.e. the densification of the gelatin precursor relevant to any film sol-gel prepared. It is therefore highly surprising that the film according to the present invention shows thicknesses exceeding 100 micrometers and no erosion, separation or break trend.

The remarkable property picture of the inventive glassy film is completed by the metallographic analysis results outlining a glass/metal interface characterized by a perfect adhesion. Microhardness measurements add thereto, showing flexibility properties generally pertaining to a metal, which knowingly is a tenacious and ductile material, instead of a glass which is a typical hard and brittle material.

The analyses of the known specific and technical literature in the field, emphasizes the long search pathway to get materials endowed with the glass corrosion resistance and the metal tenacity: see, for instance, H. Scholtze in “Glass: nature, structure and Properties”, 1991, Springer-Verlag, New York, Inc.

In the section “Metallic Glasses”, page 152, there is a disclosure about the preparation of “amorphous metals” having the metal ductility and the glass corrosion resistance, which are substantially obtained by a very fast cooling (˜10⁸k/s) of melted metal, or metal alloys. Filament and film are the only possible morphologies because of the process limits due to the fast heat removal from the material. A wide relevant bibliography is given at the section beginning. That process is carried out under extreme conditions, by using materials mainly constituted by metals, gold above all.

With reference to this frame, it is possible to outline the innovativity relevant to the object according to the present invention: the process is carried out at room temperature, or slightly higher, by starting from usual and simply formulated precursors; the obtained material shows the aimed characteristics of adhesion and durability, suitable to englobe, just in the formulation step, active compounds as particles and simple shapes able to give the very material functional properties, once deposited as film. These characteristics support the substantial inventive step in the field of the glassy films, quite useful for industrial applications such as the use of tenacious glassy films to warrant surface functional properties to suitable industrial panels, mainly stainless steel sheets.

### EXAMPLES 1 AND 2

Some structures were prepared by commercial stainless steel, of the AISI 316L kind, under the shape of a planar carrier having 10 mm×50 mm sizes and a 3 mm thickness. The structures were treated by n-heptane to free the surface from the possible working residues constituted by oily traces. A sol was prepared by pouring the following reactants into a lab glass vessel, under stirring:

| | |
|---|---|
| NaH₂PO₃H₂O | g. 8.371 |
| Al(CH₃CH₂CH₃)₃ | g. 7.076 |
| H₃PO₄ (85%) | g. 15.314 |
| H₂O | g. 25.304 |

The mixture was kept under stirring along 2 hours: a limpid solution was obtained. Under a suitable stirring, the solution obtained thereby was added by an amount of 4,5 g of microcrystalline titanium dioxide, sold by Degussa under the commercial code P-25.

The obtained product was a light opaque suspension, very clear neutral coloured, which apparently was more viscous than the starting transparent solution.

The previously prepared structure was coated by a glassy film through immersion and gradual extraction in the previously prepared sol (“dip-coating”), and a subsequent thermal treatment in oven at 350° C. along an effective time higher than 10 minutes.

The sample extraction speed from sol was modified from 10 cm/sec in the first extraction, sample 1, to 5 cm/sec in the second extraction, sample 2, to obtain samples having different thickness.

The samples obtained thereby were suitably analyzed to evaluate the interface properties of the glassy film with the underlying metal surface. The results were summarized as follows.

Macroscopic Analysis: the film surface clearly showed a compact aspect, grey coloured to light pale, and was abrasion resistant.

50× micrographs emphasize a quite rough surface with frequent roundings and apparent porosity. The surface of the film 2 is more thin than the film 1 surface, which in turn is more rough.

Thickness measurements: sections perpendicular to the carrier plane emphasize a film average thickness of 100 micrometers in the sample 1, and of 55 micrometers in the sample 2.

Metallographic Analysis: the film very high adhesion to the metal carrier was emphasized by the perfect correspondence, symmetrically reversed, of all surfaces defects of the metal substrate onto the film bottom surface, as shown by the ????section??? micrographs of both samples at enlargements up to 500× (FIG. 1/2).

Microhardness Measurements:

microhardness HV 0.05

| Sample | Measurement 1 | Measurement 2 |
|---|---|---|
| 1 | 327 | 328 |
| 2 | 350 | 345 |

### EXAMPLE 3

According to the formulations and the procedures of the preceding examples, a film was prepared by the sol obtained from the only “clear solution” on AISI 316L stainless steel structure quite similar to the ones employed in the preceding examples, without any addiction of microcrystalline titanium.

The obtained film, having compact appearance, gery colour, abrasion good resistance, was subjected to a thermal treatment in oven at 350° C. over an effective time higher than 10 minutes.

Aside a sol was prepared containing titanium dioxide according to the following procedure for the preparation of the film sol with Si/Ti molar ratio equal to 50:50.

Owing to the different hydrolysis speed between silicon alcoxide and titanium alcoxide as well as to the relevant optimizing conditions, it was convenient to hydrolyze separately two above alcoxides. Therefore two sols were prepared, the former with titanium tetraisopropylate Ti[OCH(CH₃)₂]₄ and the latter with methyltriethoxysilicate [MTEOS]; subsequently they were mixed together.

Composition of the Portion Comprising Titanium Sol

| Compound | Weight (g) |
|---|---|
| Ti[OCH(CH₃)₂]₄ | 12.78 |
| Acetylacetone | 9.54 |
| Acetone | 20.82 |
| 5,17 NHCl | 2.7 |

Preparation of the Portion Comprising Titanium Sol

In the preparation, Ti[OCH(CH₃)₂]₄ was gradually poured into acetylacetone acting as complexant. The solution, suddenly heated and red coloured, was mixed with a magnetic stirrer for some minutes and then cooled. At room temperature, acetone was added, the whole was mixed for some minutes, then HCl was added, too, and the whole was again mixed for some minutes. Sol was then kept resting, while the silicon portion had being prepared.

Composition of the Portion Comprising Silicon

| Compound | Weight (g) |
|---|---|
| SiCH₃(OCH₃)(MTEOS) | 8.02 |
| Acetone | 2.61 |
| 1 NHCl | 1.46 |

Preparation of the Portion Comprising Silicon

In the preparation, MTEOS was first added to acetone and mixed with a magnetic stirrer for some minutes; then HCl was gradually added under stirring. The solution was kept under stirring for about one minute, in which a light heating signed the occurred hydrolysis. At that point sol was immediately added to the titanium one, previously prepared; the whole was still kept under stirring for some minutes.

The titanium dioxide containing sol was used to deposit a film on the previously coated structure. The deposition method again was through immersion and gradual extraction of the carrier from sol (dip-coating). The obtained product was thermally treated in air at 350° C. for an effective time of at least 10 minutes.

The sample obtained thereby was subjected to the same analyses of the sample prepared in the preceding examples.

The results were summarized as follows.

Macroscopic analysis: the film surface clearly showed an unfinished appearance, even if compact, a grey colour more evident than the one of the preceding example, an abrasion good resistance. 50× micrographs emphasize relatively wide hollows and porosity apparent presence.

Thickness measurement: sections perpendicular to the carrier surface emphasize an average thickness of 30 micrometers (sample 3).

Metallographic analysis: very high adhesion of film to the metal carrier as in the samples of the examples 1 and 2.

Microhardness Measurements:

microhardness HV 0.05

| Sample | Measurement 1 | Measurement 2 |
|---|---|---|
| 3 | 301 | 315 |
| AISI 316L steel | 330 | 358 |

### EXAMPLE 4

Samples of the AISI 316L stainless steel structures, in cylindrical shape with 4 mm diameter and 18 mm height were coated by a glassy film through the same procedure of sample 1 of example 1. A lot of six samples was prepared, identified as 1a, 1b, 1c, 1d, 1e, 1f.

Metallic structure samples, as above said, were coated by a glassy film through the same procedure of sample 3 of example 3. A lot of six samples was prepared, identified as 3a, 3b, 3c, 3d, 3e, 3f.

Metallic structure samples, as above said, were coated by a glassy film made only by “transparent sol” (without any TiO₂ addition) as a control. A lot of six samples was prepared, identified as 4a, 4b, 4c, 4d, 4e, 4f.

The three above said series were treated by the University of Piemonte Orientale “Amedeo Avogadro” quartering in Novara, Medicine and Surgery Department, in order to outline the photogermicide activity of the TiO₂ containing samples. The photobactericide activity of the experimental samples was evaluated on Escherichia coli cultures. During a first preliminar experiment, three samples of each serie, suitable light conditioned, were composed to their unconditioned corresponding ones. Preliminar results confirmed the high photobactericide efficiency of the TiO₂ containing coatings, both microcrystalline according to example 1 and originally molecular according to example 3.

1. An inorganic glassy film having a high chemical stability and a very high adhesion to oxide containing metal surfaces formed by a composition comprising an alkaline metal oxide, an oxide of an element belonging to the 3^{rd} Group of the Element Periodic System, one phosphorous oxide, and titanium dioxide, wherein the titanium dioxide is present in an amount not lower than 0.1% by weight.

2. The inorganic glassy film according to claim 1 wherein the titanium dioxide is microcrystalline, well dispersed, and has an anatase crystalline shape.

3. The inorganic glassy film according to claim 1 comprising constituents in the reported weight concentration ranges:
5%≦Na₂O≦65%
20%≦Al₂O₃≦70%
25%≦P₂O₃≦90%
0.1%≦TiO₂≦15%

4. A metallic substrate coated by the film according to claim 1.

5. The coated metallic substrate of claim 4 according to claim 4 wherein the metallic substrate is made by stainless steel.

6. The coated metallic substrate of claim 4 according to claim 5 wherein the coating film has a tenacious characteristic.
